(19) United States
(12) Patent Application Publication
(10) Pub. No.: US 2007/0209550 A1
(43) Pub. Date: Sep. 13, 2007

(54) WATER-BASED INK

(75) Inventors: Isao Tsuru, Wakayama-shi (JP); Kenji Kaida, Sumida-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kao Corporation, Tokyo (JP)

(21) Appl. No.: 11/750,061

(22) Filed: May 17, 2007

Related U.S. Application Data
(63) Continuation of application No. 10/633,705, filed on Aug. 5, 2003.

(30) Foreign Application Priority Data
Aug. 7, 2002 (JP) 2002-229952

(51) Int. Cl. C09D 11/10

(52) U.S. Cl. 106/31.6

(57) ABSTRACT

An aqueous dispersion comprising water-insoluble vinyl polymer particles containing C. I. Pigment Blue 15:4 as a colorant; and a water-based ink containing the aqueous dispersion. The water-based ink containing the aqueous dispersion can be suitably used as a water-based ink for inkjet recording and the like.

### BACKGROUND OF THE INVENTION

1. Field of the Invention

The present invention relates to an aqueous dispersion and a water-based ink containing the aqueous dispersion. More specifically, the present invention relates to an aqueous dispersion containing polymer particles and a water-based ink containing the aqueous dispersion, which can be suitably used as a water-based ink for inkjet recording and the like.

2. Discussion of the Related Art

Inkjet recording is a recording system for forming characters or images, comprising directly jetting ink droplets from very fine nozzles to a recording medium, and depositing the ink droplets on the recording medium. This system has some advantages such that not only the device shows excellent operability at a low level of noise, but also the coloration is facilitated and a plain sheet of paper can be used as a recording medium. Therefore, this system has been widely used. As an ink used for inkjet printers, a water-soluble dye-containing ink has been mainly used. Since the water-soluble dye-containing ink exhibits very vivid colors and the dye is dissolved in water, the transparency of the ink is high and the hue is vivid.

However, there are some disadvantages in using dye such that the dye has poor light fastness, and that the dye has poor water resistance since the dye is water-soluble.

In order to eliminate these disadvantages, there has been used a pigment excellent in light fastness and water resistance in recent years.

A pigment has an advantage such that the pigment does not dissolve in water and is excellent in light fastness. However, there has been known to cause a so-called bronze phenomenon in a pigment-based ink in which the pigment is used, such that a color different from the original color of the pigment appears on the surface due to the influence of the pigment particles existing on the surface of the printout. This phenomenon is a so-called bronze phenomenon, and changed by the angle at which the printout is observed, and most remarkably appears when the printout is observed at an angle opposite to the angle of incidence. Therefore, the pigment-based ink has angular dependency of color tone. On the other hand, since the dye-based ink does not angular dependency, it is required that the pigment-based ink has no angular dependency as well as the dye-based ink.

In an ink set comprising three colors of cyan ink, magenta ink and yellow ink, there exists angular dependency of color tone between each of the color inks. Among them, an ink most clearly showing a change in color tone is cyan ink. In the cyan ink, a copper phthalocyanine pigment has been widely used. Among them, C.I. Pigment Blue 15:3 has been most widely used. However, there is a disadvantage in the cyan ink in which C.I. Pigment Blue 15:3 is used, such that the cyan ink has a large angular dependency.

Generally, in a water-based ink containing an aqueous dispersion of water-soluble vinyl polymer particles containing a pigment, there has been known a method for reducing angular dependency, comprising increasing the weight ratio of the polymer to the pigment. According to this method, although the angular dependency of the color tone can be somewhat reduced, the extent of reduction is still not satisfactory.

In order to increase the optical density of the pigment-based ink, there have been proposed addition of a polymer containing a polyethylene glycol (meth)acrylate monomer and an α, β-ethylenic unsaturated carboxylic acid (Japanese Patent Laid-Open No. Hei 6-306317), addition of a polymeric dispersant made of a polyethylene glycol (meth)acrylate monomer or a poly(propylene glycol) (meth)acrylate monomer (Japanese Patent Laid-Open No. 2000-144031), and the like. Also, in order to improve jetting stability of the pigment-based ink, there have been proposed addition of fine polymer particles (Japanese Patent Laid-Open Nos. Hei 8-218015, Hei 8-151544 and Hei 8-176488), addition of an ethylene oxide adduct (Japanese Patent Laid-Open No. Hei 8-176481), and the like.

However, there are some disadvantages in a polymer prepared by copolymerizing a (meth)acrylate monomer having an oxyethylene group or an oxytrimethylene group as a nonionic component in excess, such that the polymer easily penetrates into a plain sheet of paper because the polymer itself is highly hydrophilic, thereby lowering its optical density when printing, and that it is difficult to secure stable jetting stability because such an ink containing the polymer shows high viscosity due to its hydrophilic property.

### SUMMARY OF THE INVENTION

The present invention relates to an aqueous dispersion comprising water-insoluble vinyl polymer particles, wherein the particles contain C. I. Pigment Blue 15:4 as a colorant, and a water-based ink containing the aqueous dispersion.

### DETAILED DESCRIPTION OF THE INVENTION

The term “(meth)acryl” as referred to herein means “acryl” or “methacryl.”

The present invention relates to an aqueous dispersion and a water-based ink containing the aqueous dispersion, which is excellent in angular dependency of color tone, water resistance, light-fastness, rubbing resistance, gloss and dispersion stability.

The present invention also relates to a water-based ink for inkjet recording, which is excellent in jetting stability and capable of giving a printout high optical density.

These and other advantages of the present invention will be apparent from the following description.

One of the advantages of the present invention resides in that C.I. Pigment Blue 15:4, which has not been so frequently used in cyan ink, is used in place of C.I. Pigment Blue 15:3 as a colorant used in a water-based ink containing an aqueous dispersion of water-insoluble vinyl polymer particles containing a colorant.

Commercially available C.I. Pigment Blue 15:4 includes, for instance, products commercially available from DAINIPPON INK & CHEMICALS, INC. under the trade name of Fastogen Blue TGR-1, products commercially available from Toyo Ink Manufacturing Co., Ltd. under the trade name of LIONOL BLUE FG-7400-G, and the like.

Although not wanting to be limited by theory, since C.I. Pigment Blue 15:4 is selectively used and the pigment is included in the polymer particles, the angular dependency of the color tone is believed to be remarkably reduced.

It is preferable that the amount of the polymer is larger from the viewpoint of reducing angular dependency of the color tone. However, when the amount of the polymer too large, the viscosity of the aqueous dispersion becomes higher, so that the viscosity of the ink exceeds an appropriate level. Therefore, the amount of the polymer is preferably 10 to 500 parts by weight, more preferably 20 to 200 parts by weight based on 100 parts by weight of C.I. Pigment Blue 15:4.

In the water-based ink of the present invention, a water-insoluble vinyl polymer is used as a polymer, from the viewpoint of increasing the adsorptivity to the pigment.

Representative examples of the water-insoluble vinyl polymer include a water-insoluble vinyl polymer obtained by polymerizing a monomer composition (hereinafter simply referred to as a “monomer composition”) comprising:
(A) 0 to 45% by weight of a monomer A represented by formula (I): 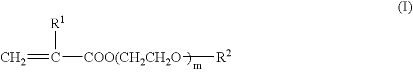
wherein R¹ is a hydrogen atom or a methyl group; R² is a hydrogen atom, an alkyl group having 1 to 20 carbon atoms or a phenyl group which may have an alkyl group having 1 to 9 carbon atoms; and m is a number of 1 to 30 (hereinafter simply referred to as “monomer A”);
(B) 0 to 45% by weight of at least one monomer B (hereinafter simply referred to as “monomer B”) selected from the group consisting of:
a monomer B1 represented by formula (II): 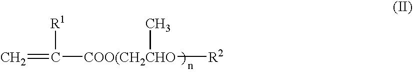
wherein R¹ and R² are as defined above; and n is a number of 1 to 30 (hereinafter simply referred to as “monomer B1”),
a monomer B2 represented by formula (III): 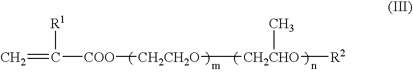
wherein R¹, R², m and n are as defined above, and oxyethylene group and oxypropylene group are added in a block or random form (hereinafter simply referred to as “monomer B2”), and
a monomer B3 represented by formula (IV): 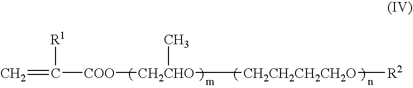
wherein R¹, R², m and n are as defined above, and oxypropylene group and oxytetramethylene group are added in a block or random form (hereinafter simply referred to as “monomer B3”);
(C) 3 to 40% by weight of a monomer having a salt-forming group; and
(D) 15 to 87% by weight of a copolymerizable monomer copolymerizable with the monomer A, the monomer B1, the monomer B2, the monomer B3 and the monomer having a salt-forming group (hereinafter simply referred to as “copolymerizable monomer”),
wherein the total content of the monomer A and the monomer B is at least 5% by weight.

In the formulae (I) to (IV), R¹ is a hydrogen atom or a methyl group. R² is a hydrogen atom, an alkyl group having 1 to 20 carbon atoms or a phenyl group which may have an alkyl group having 1 to 9 carbon atoms. Concrete examples of R² include, for instance, a methyl group, an ethyl group, an i-propyl group, a n-propyl group, a n-butyl group, a t-butyl group, a n-octyl group, a 2-ethylhexyl group, a decyl group, a lauryl group, a myristyl group, a cetyl group, a stearyl group, a phenyl group, a nonylphenyl group and the like.

m is a number of 1 to 30, and preferably a number of 2 to 25 from the viewpoints of jetting stability and optical density.

n is a number of 1 to 30, and preferably a number of 2 to 25 from the viewpoints of jetting stability and optical density. In the monomer B2, oxyethylene groups and oxyethylene groups are added in a block or random form. In the monomer B3, oxypropylene groups and oxytetramethylene groups are added in a block or random form.

A water-based ink which forms a printed image having more excellent gloss can be obtained by using a monomer A in the water-insoluble vinyl polymer. The reason why a printed image having more excellent gloss can be formed is thought to be based on the fact that the hydrophilic hydration layer of highly hydrophilic oxyethylene group of the monomer A is widely dispersed in the water-based ink.

Representative examples of the monomer A include polyethylene glycol mono(meth)acrylate and the like. Concrete examples of the monomer A include monomers commercially available from Shin-Nakamura Chemical Co., Ltd. under the trade names of NK ESTER M-20G, 40G, 90G and 230G; monomers commercially available from NOF Corporation under the trade names of Blemmer PE Series, PME-100, 200, 400, 1000 and the like.

The content of the monomer A in the monomer composition is 0 to 45% by weight, preferably 5 to 45% by weight, more preferably 5 to 35% by weight from the viewpoints of gloss and optical density of a printout.

When the monomer B1, the monomer B2 or the monomer B3 is used in the water-insoluble vinyl polymer, a water-based ink which is excellent in jetting stability can be obtained. The reason why excellent jetting stability is exhibited is thought to be based on the fact that hydrophobic interaction between oxypropylene group having high hydrophobicity of the monomer B1, the monomer B2 or the monomer B3 and the colorant becomes stronger, so that the water-insoluble vinyl polymer exhibits stronger adsorptivity to the colorant. Therefore, the hydrophobicity of the polymer particles containing a colorant increases, thereby resulting in lowering the viscosity of the water-based ink.

Also, since the monomer B1, the monomer B2 or the monomer B3 is used in the water-insoluble vinyl polymer, the water-insoluble vinyl polymer can give the colorant excellent dispersion stability. The reason why the excellent property is exhibited is thought to be based on the fact that a hydrophobic hydration layer having a highly hydrophilic oxyethylene group, oxypropylene group or oxytetramethylene group is dispersed in the water-based ink.

Concrete examples of the monomer B1 includes polypropylene glycol mono(meth)acrylates and the like.

Concrete examples of the monomer B2 include ethylene glycol•propylene glycol (meth)acrylate, poly(ethylene glycol•propylene glycol) mono(meth)acrylate, octoxypolyethylene glycol•polypropylene glycol mono(meth)acrylate, octoxypoly(ethylene glycol•polypropylene glycol) mono(meth)acrylate, stearoxypolyethylene glycol•polypropylene glycol mono(meth)acrylate, stearoxypoly(ethylene glycol•propylene glycol) mono(meth)acrylate, nonylphenoxypolyethylene glycol•polypropylene glycol mono(meth)acrylate, nonylphenoxypoly(ethylene glycol•propylene glycol) mono(meth)acrylate, and the like. These monomers can be used alone or in admixture of at least two kinds.

Concrete examples of the monomer B3 include propylene glycol•tetramethylene glycol mono(meth)acrylate, poly(propylene glycol•tetramethylene glycol) mono(meth)acrylate, propylene glycol•polybutylene glycol mono(meth)acrylate, poly(propylene glycol•butylene glycol) mono(meth)acrylate, and the like. These monomers can be used alone or in admixture of at least two kinds.

Among the monomer B1, the monomer B2 and the monomer B3, polypropylene glycol mono(meth)acrylate, ethylene glycol•propylene glycol (meth)acrylate and poly(ethylene glycol•propylene glycol) mono(meth)acrylate are preferable from the viewpoints of viscosity of an ink and jetting stability.

Examples of the monomer B1, the monomer B2 and the monomer B3 include monomers commercially available from NOF Corporation under the trade names of Blemmer PP-1000, PP-500, PP-800, AP-150, AP-400, AP-550, AP-800, 50PEP-300, 70PEP-350B, AEP Series, 30PPT-800, 50PPT-800, 70PPT-800, APT Series, 10PPB-500B, 10APB-500B, 50POEP-800B, 50AOEP-800B, ASEP Series, PNEP Series, PNPE Series, 43ANEP-500, 70ANEP-550, and the like.

The content of the monomer B in the monomer composition is 0 to 45% by weight, preferably 5 to 45% by weight, more preferably 5 to 35% by weight from the viewpoints of jetting stability and high optical density of a printout.

The total content of the monomer A and the monomer B is at least 5% by weight, preferably 5 to 45% by weight, more preferably 5 to 35% by weight from the viewpoints of high optical density of a printout. It is preferable that the monomer A and at least one member selected from the group consisting of the monomer B1, the monomer B2 and the monomer B3 are used together from the viewpoints of gloss of a printout and jetting stability.

As the monomer having a salt-forming group, anionic monomers and cationic monomers are preferable. The anionic monomers and the cationic monomers can be used alone or in admixture of at least two kinds.

The anionic monomer includes at least one monomer selected from the group consisting of unsaturated carboxylic acid monomers, unsaturated sulfonic acid monomers and unsaturated phosphoric acid monomers.

The unsaturated carboxylic acid monomer includes, for instance, acrylic acid, methacrylic acid, crotonic acid, itaconic acid, maleic acid, fumaric acid, citraconic acid, 2-methacryloyloxymethyl succinic acid and the like. These monomers can be used alone or in admixture of at least two kinds.

The unsaturated sulfonic acid monomer includes, for instance, styrenesulfonic acid, 2-acrylamide-2-methylpropanesulfonic acid, 3-sulfopropyl (meth)acrylate, bis(3-sulfopropyl)itaconate and the like. These monomers can be used alone or in admixture of at least two kinds.

The unsaturated phosphate monomer includes, for instance, vinylphosphonic acid, vinyl phosphate, bis(methacryloxyethyl)phosphate, diphenyl-2-acryloyloxyethyl phosphate, diphenyl-2-methacryloyloxyethyl phosphate, dibutyl-2-acryloyloxyethyl phosphate and the like. These monomers can be used alone or in admixture of at least two kinds.

Among the anionic monomers, the unsaturated carboxylic acid monomers are preferable, and acrylic acid and methacrylic acid are more preferable from the viewpoints of viscosity of an ink and jetting stability.

The cationic monomer includes at least one monomer selected from the group consisting of tertiary amine-containing unsaturated vinyl monomers and ammonium salt-containing unsaturated vinyl monomers.

The tertiary amine-containing unsaturated vinyl monomer includes, for instance, N,N-dimethylaminoethyl(meth)acrylate, N,N-dimethylaminopropyl (meth)acrylate, N,N-diethylaminoethyl(meth)acrylate, N,N-dimethylaminopropyl(meth)acrylamide, an N,N-dimethylarylamine, vinylpyrrolidone, 2-vinylpyridine, 4-vinylpyridine, 2-methyl-6-vinylpyridine, 5-ethyl-2-vinylpyridine and the like. These monomers can be used alone or in admixture of at least two kinds.

The ammonium salt-containing unsaturated vinyl monomer includes, for instance, quaternarized N,N-dimethylaminoethyl(meth)acrylate, quaternarized N,N-diethylaminoethyl(meth)acrylate, quaternarized N,N-dimethylaminopropyl (meth)acrylate and the like. These monomers can be used alone or in admixture of at least two kinds.

Among these cationic monomers, N,N-dimethylaminoethyl(meth)acrylate, N,N-dimethylaminopropyl(meth)acrylamide and vinylpyrrolidone are preferable.

The content of the monomer having a salt-forming group in the monomer composition is preferably 3 to 40% by weight, more preferably 5 to 30% by weight from the viewpoints of dispersion stability and jetting stability.

The copolymerizable monomer includes, for instance, (meth)acrylates, aromatic group-containing monomers, macromers, and the like. These monomers can be used alone or in admixture of at least two kinds. It is preferable that the copolymerizable monomer contains at least one monomer selected from the group consisting of aromatic group-containing monomers and macromers from the viewpoints of water resistance and rubbing resistance.

The (meth)acrylate includes, for instance, (meth)acrylates of which ester moiety has an alkyl group having 1 to 18 carbon atoms, such as methyl (meth)acrylate, ethyl(meth)acrylate, (iso)propyl(meth)acrylate, (iso or tertiary)butyl(meth)acrylate, (iso)amyl(meth)acrylate, cyclohexyl (meth)acrylate, 2-ethylhexyl(meth)acrylate, (iso)octyl(meth)acrylate, (iso)decyl (meth)acrylate, (iso)dodecyl(meth)acrylate and (iso)stearyl(meth)acrylate. These (meth)acrylates can be used alone or in admixture of at least two kinds.

The above-mentioned “(iso or tertiary)” and “(iso)” include both of the case where these groups are present and the case where these groups are absent. When these groups are absent, the monomer is in the form of normal.

It is preferable that the aromatic ring-containing monomer is at least one monomer selected from the group consisting of styrene, vinylnaphthalene, α-methylstyrene, vinyltoluene, ethylvinylbenzene, 4-vinylbiphenyl, 1,1-diphenylethylene, benzyl(meth)acrylate, phenoxyethyl(meth)acrylate, 2-hydroxy-3-phenoxypropyl acrylate, 2-methacryloyloxyethyl-2-hydroxypropyl phthalate, 2-acryloyloxyethyl phthalate and neopentyl glycol acrylate benzoate from the viewpoint of water resistance. Among them, at least one monomer selected from the group consisting of styrene, α-methylstyrene, vinyltoluene and vinylnaphthalene is preferable from the viewpoints of water resistance and rubbing resistance.

Representative examples of the macro mer include a macromer having a polymerizable functional group at one end and a number-average molecular weight of preferably 500 to 500000, more preferably 1000 to 10000.

Concrete examples of the macromer include styrenic macromers having a polymerizable functional group at one end, silicone macromers having a polymerizable functional group at one end, methyl methacrylate macromers having a polymerizable functional group at one end, styrene-acrylonitrile macromers having a polymerizable functional group at one end, butyl acrylate macromers having a polymerizable functional group at one end, isobutyl methacrylate macromers having a polymerizable functional group at one end, and the like. Among them, the styrenic macromers having a polymerizable functional group at one end are preferable from the viewpoint of sufficiently including the colorant in the water-insoluble vinyl polymer.

The styrenic macromer having a polymerizable functional group at one end includes a styrene homopolymer having a polymerizable functional group at one end, and a copolymer of styrene and other monomer, having a polymerizable functional group at one end.

In the copolymer of styrene and other monomer, having a polymerizable functional group at one end, the other monomer includes, for instance, acrylonitrile and the like. The content of styrene in the copolymer is preferably at least 60% by weight, more preferably at least 70% by weight from the viewpoint of sufficiently including a pigment in the water-insoluble vinyl polymer.

Among the styrenic macromers having a polymerizable functional group at one end, styrenic macromers having an acryloyl group or a methacryloyl group at one end as a polymerizable functional group are preferable.

Commercially available styrenic macromers include, for instance, styrenic macromers commercially available from TOAGOSEI CO., LTD. under the trade names of AS-6, AN-6, AN-6S, HS-6S, HS-6 and the like.

Among the silicone macromers, a silicone macromer represented by formula (V):
X(Y)_{q}Si(R³)₃₋ᵣ(Z)ᵣ (V)
wherein X is a polymerizable unsaturated group; Y is a divalent group; each of R³ is independently a hydrogen atom, a lower alkyl group, an aryl group or an alkoxy group; Z is a monovalent siloxane polymer residue having a number-average molecular weight of at least 500; q is 0 or 1; and r is an integer of 1 to 3, is preferable from the viewpoint of preventing scorching on the printer head of an inkjet printer.

In the silicone macromer represented by formula (V), X is a polymerizable unsaturated group. Representative examples of the polymerizable unsaturated group include a monovalent unsaturated hydrocarbon group having 2 to 6 carbon atoms, such as CH₂═CH— group or CH₂═C(CH₃)— group.

Y is a divalent group. Representative examples of the divalent group include —COO— group, a —COOCₐH₂ₐ— group wherein a is an integer of 1 to 5, phenylene group and the like. Among them, —COOC₃H₆— is preferable.

Each of R³ is independently a hydrogen atom, a lower alkyl group, an aryl group or an alkoxy group. Concrete examples of R³ include a hydrogen atom; a lower alkyl group having 1 to 5 carbon atoms, such as a methyl group or an ethyl group; an aryl group having 6 to 20 carbon atoms, such as phenyl group; an alkoxy group having 1 to 20 carbon atoms, such as methoxy group; and the like. Among them, the methyl group is preferable.

Z is preferably a monovalent siloxane polymer residue having a number-average molecular weight of at least 500. Z is preferably a monovalent dimethylsiloxane polymer residue having a number-average molecular weight of 500 to 5000.

q is 0 or 1, and preferably 1. r is an integer of 1 to 3, and preferably 1.

Representative examples of the silicone macromer include a silicone macromer represented by formula (VI):
CH₂═CR³—COOC₃H₆—[Si(R⁴)₂—O]_{b}—Si(R⁴)₃ (VI)
wherein R³ is a hydrogen atom or a methyl group; each of R⁴ is independently hydrogen atom or a lower alkyl group having 1 to 5 carbon atoms; and b is a number of 5 to 60;
a silicone macromer represented by formula (VII):
CH₂═CR³—COO—[Si(R⁴)₂—O]_{b}—Si(R⁴)₃ (VII)
wherein R³, R⁴ and b are the same as defined above;
a silicone macromer represented by formula (VIII):
CH₂═CR³-Ph-[Si(R⁴)₂—O]_{b}—Si(R⁴)₃ (VIII)
wherein Ph is phenylene group; and R³, R⁴ and b are the same as defined above; a silicone macromer represented by formula (IX):
CH₂═CR³—COOC₃H₆—Si(OE)₃ (IX)
wherein R³ is the same as defined above; E is a group represented by formula: —[Si(R³)₂—O]_{c}—Si(R³)₃ wherein R³ is the same as defined above, and c is a number of 5 to 65;
and the like.

Among these silicone macromers, the silicone macromer represented by formula (VI) is preferable, and a silicone macromer represented by formula (X):
CH₂═C(CH₃)—COOC₃H₆—[Si(CH₃)₂—O]_{d}—Si(CH₃)₃ (X)
wherein d is a number of 8 to 40,
is especially preferable. Concrete examples of the silicone macromer include a silicone macromer commercially available from CHISSO CORPORATION under the trade name of FM-0711, and the like.

The number-average molecular weight of the macromer is determined by gel permeation chromatography using polystyrene as a standard substance and chloroform containing 1 mmol/L dodecylmethylamine as a solvent.

The content of the copolymerizable monomer in the monomer composition is 15 to 87% by weight, preferably 35 to 85% by weight from the viewpoints of optical density and water resistance.

Also, the content of the aromatic ring-containing monomer in the monomer composition is preferably 0.1 to 70% by weight, more preferably 1 to 50% by weight from the viewpoints of water resistance, rubbing resistance, viscosity of an ink and jetting stability.

The content of the macromer in the monomer composition is preferably 0.1 to 40% by weight, more preferably 1 to 30% by weight from the viewpoints of water resistance and rubbing resistance.

The weight-average molecular weight of the water-insoluble vinyl polymer is preferably 3000 to 300000, more preferably 5000 to 200000 from the viewpoints of optical density and jetting stability. The weight-average molecular weight of the water-insoluble vinyl polymer is determined by the method described in Preparation Examples 1 to 3 given below.

The water-insoluble vinyl polymer can be prepared by polymerizing a monomer composition by a known polymerization method such as a bulk polymerization method, a solution polymerization method, a suspension polymerization method or an emulsion polymerization method. Among these polymerization methods, the solution polymerization method is preferable.

The solvent used in the solution polymerization method is preferably a polar organic solvent. When the polar organic solvent is a water-miscible organic solvent, the water-miscible organic solvent can be also used in admixture with water.

The polar organic solvent includes, for instance, aliphatic alcohols having 1 to 3 carbon atoms, such as methanol, ethanol and propanol; ketones such as acetone and methyl ethyl ketone; esters such as ethyl acetate; and the like. Among them, methanol, ethanol, acetone, methyl ethyl ketone or a mixture of the solvent and water is preferable.

A radical polymerization initiator can be used in the polymerization. As the radical polymerization initiator, azo compounds such as 2,2′-azobisisobutyronitrile, 2,2′-azobis(2,4-dimethylvaleronitrile), dimethyl-2,2′-azobisbutyrate, 2,2′-azobis(2-methylbutyronitrile) and 1,1′-azobis(1-cyclohexanecarbonitrile) are preferable. Also, there can be used organic peroxides such as t-butyl peroxyoctoate, di-t-butyl peroxide and dibenzoyl oxide.

The amount of the polymerization initiator is preferably 0.001 to 5 mol, more preferably 0.01 to 2 mol per 1 mol of the monomer composition.

In the polymerization, a polymerization chain transfer agent can be added thereto. Concrete examples of the polymerization chain transfer agent include mercaptans such as octyl mercaptan, n-dodecyl mercaptan, t-dodecyl mercaptan, n-tetradecyl mercaptan and 2-mercaptoethanol; xanthogenndisulfides such as dimethyl xanthogenndisulfide and diisopropyl xanthogenndisulfide; thiuram disulfides such as tetramethyl thiuram disulfide and tetrabutyl thiuram disulfide; halogenated hydrocarbons such as carbon tetrachloride and ethylene bromide; hydrocarbons such as pentaphenylethane; unsaturated cyclic hydrocarbon compounds such as acrolein, methacrolein, allyl alcohol, 2-ethylhexyl thioglycolate, terpinolene, α-terpinene, γ-terpinene, diterpene, α-methylstyrene dimer, 9,10-dihydroanthracene, 1,4-dihydronaphthalene, indene and 1,4-cyclohexadiene; unsaturated heterocyclic compounds such as 2,5-dihydrofuran; and the like. Those polymerization chain transfer agents can be used alone or in admixture of at least two kinds.

The conditions for polymerizing the monomer composition cannot be absolutely determined because the conditions differ depending upon kinds of the radical polymerization initiator, the monomers and the solvent used, and the like. Usually, the polymerization temperature is preferably 30° to 100° C., more preferably 50° to 80° C., and the polymerization time is preferably 1 to 20 hours. It is preferable that the atmosphere for polymerization is an inert gas such as nitrogen gas.

After the termination of the polymerization reaction, the formed water-insoluble vinyl polymer can be isolated from the reaction solution by a known method such as re-precipitation or solvent distillation. The formed water-insoluble vinyl polymer can be purified to remove unreacted monomers and the like from the water-insoluble vinyl polymer by the repeat of re-precipitation, membrane separation, a chromatographic method, an extraction method or the like.

As the organic solvent, hydrophilic organic solvents such as alcoholic solvents, ketone solvents and ether solvents are preferable.

The alcoholic solvent includes, for instance, methanol, ethanol, isopropanol, n-butanol, tertiary butanol, isobutanol, diacetone alcohol and the like.

The ketone solvent includes, for instance, acetone, methyl ethyl ketone, diethyl ketone, methyl isobutyl ketone and the like. The ether solvent includes, for instance, dibutyl ether, tetrahydrofuran, dioxane and the like. Among these solvents, isopropanol, acetone and methyl ethyl ketone are preferable.

Also, the above-mentioned organic solvent and a hydrophilic organic solvent having a high boiling point can be used together as occasion demands. The hydrophilic organic solvent having a high boiling point includes, for instance, phenoxyethanol, ethylene glycol monomethyl ether, diethylene glycol monomethyl ether, diethylene glycol monoethyl ether, diethylene glycol diethyl ether, and the like.

As the neutralizing agent, an acid or a base can be used depending upon the kind of the salt-forming group of the polymer. The acid includes, for instance, inorganic acids such as hydrochloric acid and sulfuric acid; and organic acids such as acetic acid, propionic acid, lactic acid, succinic acid, glycollic acid, gluconic acid and glyceric acid. The base includes, for instance, tertiary amines such as trimethylamine and triethylamine, ammonia, sodium hydroxide, potassium hydroxide and the like.

The neutralization degree is not limited to specified ones. It is preferable that the resulting aqueous dispersion is usually neutral, for instance the pH of the aqueous dispersion is 4.5 to 10. The solubility of the water-insoluble vinyl polymer in water at 25° C. after the neutralization is preferably at most 10% by weight, more preferably at most 5% by weight, still more preferably at most 1% by weight from the viewpoint of lowering the viscosity of the water-based ink.

As a method for preparing an aqueous dispersion of the polymer particles containing C. I. Pigment Blue 15:4, it is desired to use a method comprising dissolving the polymer in an organic solvent, adding C. I. Pigment Blue 15:4, water and a neutralizing agent and a surfactant as occasion demands to the resulting solution, kneading the resulting mixture, diluting the kneaded mixture with water as occasion demands, and distilling off the organic solvent to give a water-based system.

The average particle diameter of the polymer particles containing C. I. Pigment Blue 15:4 used in the aqueous dispersion and in the water-based ink is preferably 0.01 to 0.50 μm, more preferably 0.02 to 0.30 μm, still more preferably 0.05 to 0.20 μm from the viewpoints of prevention of clogging of a nozzle and dispersion stability. The average particle diameter of the polymer particles is intended to mean “average particle diameter before storage” as explained in Examples mentioned below, and determined by the method explained in the Examples.

It is preferable that the amount (amount of solid matters) of the polymer particles containing C. I. Pigment Blue 15:4 in the aqueous dispersion is preferably 1 to 30% by weight from the viewpoint of dispersion stability.

It is preferable that the amount (amount of solid matters) of the aqueous dispersion of the polymer particles containing C. I. Pigment Blue 15:4 in the water-based ink of the present invention is preferably 0.5 to 30% by weight, more preferably 1 to 15% by weight from the viewpoints of optical density and jetting stability. Also, the amount of water in the aqueous dispersion is preferably 40 to 90% by weight.

In the water-based ink of the present invention, ingredients other than he polymer particles are substantially water. If necessary, there can be contained additives such as a wetting agent, a dispersant, a defoaming agent, a mildewproof agent and a chelating agent in the water-based ink.

The wetting agent includes, for instance, polyhydric alcohols and ethers thereof such as ethylene glycol, propylene glycol, diethylene glycol, triethylene glycol, polyethylene glycol, glycerol, diethylene glycol diethyl ether and diethylene glycol mono-n-butyl ether; acetates; and nitrogen-containing compounds such as N-methyl-2-pyrrolidone and 1,3-dimethylimidazolidinone. The content of the wetting agent in the water-based ink is preferably 0.1 to 50% by weight, more preferably 0.1 to 30% by weight.

As the dispersant, there can be used anionic, nonionic, cationic and amphoteric dispersants.

The water-based ink of the present invention shows high hydrophobicity, has a low viscosity and is excellent in jetting stability and dispersion stability on the basis of the function of a hydrophobic hydration layer of oxypropylene groups ascribed to the monomer B1, the monomer B2 or the monomer B3, when at least one monomer selected from the group consisting of the monomer B1, the monomer B2 and the monomer B3 is copolymerized.

Since the pigment C. I. Pigment Blue 15:4 is used as a colorant in the water-based ink of the present invention, a printout having excellent angular dependency of color tone, light-fastness and water resistance can be obtained from the water-based ink.

Furthermore, when at least one member selected from the group consisting of the aromatic ring-containing monomers and the macromers is used in the water-insoluble vinyl polymer, a printout having more excellent water resistance and rubbing resistance can be obtained.

Also, since the preferred water-based ink of the present invention shows high hydrophobicity, the penetration of the water-based ink into paper having a hydrophilic surface is inhibited. Therefore, the colorant can effectively remain on the surface of the paper, and thereby a high optical density can be imparted to a printout.

The following examples further describe and demonstrate embodiments of the present invention. The examples are given solely for the purpose of illustration and are not to be construed as limitations of the present invention.

### EXAMPLES

### Preparation Examples 1 to 3

A reaction vessel was charged with 20 parts by weight of methyl ethyl ketone, 0.03 parts by weight of a polymerization chain transfer agent (2-mercaptoethanol) and 10% by weight of the amount of each monomer (parts by weight) shown in Table 1, and the ingredients were mixed with each other. Nitrogen gas replacement was sufficiently carried out, to give a mixed solution.

On the other hand, a dropping funnel was charged with 90% by weight of the amount (parts by weight) of each monomer shown in Table 1. Thereafter, 0.27 parts by weight of a polymerization chain transfer agent (2-mercaptoethanol), 60 parts by weight of methyl ethyl ketone and 1.2 parts by weight of 2,2′-azobis(2,4-dimethylvaleronitrile) were added thereto, and the ingredients were mixed with each other. Nitrogen gas replacement was sufficiently carried out to give a mixed solution.

The temperature of the mixed solution inside the reaction vessel was increased to 65° C. with stirring under nitrogen atmosphere, and the mixed solution inside the dropping funnel was gradually added dropwise to the reaction vessel over a period of 3 hours. After the termination of dropwise addition, the liquid temperature of the mixed solution was kept at 65° C. for 2 hours, and thereafter a solution prepared by dissolving 0.3 parts by weight of 2,2′-azobis(2,4-dimethylvaleronitrile) in 5 parts by weight of methyl ethyl ketone was added thereto. The mixture was further aged at 65° C. for 2 hours and then at 70° C. for 2 hours, to give a polymer solution.

The resulting polymer was isolated from the polymer solution by drying a part of the polymer solution at 105° C. for 2 hours under reduced pressure to remove the solvent. The weight-average molecular weight of the polymer was determined by gel permeation chromatography using polystyrene as a standard substance, and dimethylformamide containing 60 mmol/L of phosphoric acid and 50 mmol/L of lithium bromide and as a solvent. The results are shown in Table 1.

The details of the compounds shown in Table 1 are as follows:
Polyethylene glycol monomethacrylate: commercially available from Shin-Nakamura Chemical Co., Ltd. under the trade name of NK ESTER M-90G; in formula (I), m is 9, and each of R¹ and R² is a methyl group, respectively;
Polypropylene glycol monomethacrylate: commercially available from NOF Corporation under the trade name of Blemmer PP-500; in formula (II), n is 9, R¹ is a methyl group and R² is a hydrogen atom;

Styrenic macromer: commercially available from TOAGOSEI CO., LTD. under the trade name of AS-6 (styrene homopolymerized macromer), number-average molecular weight: 6000, polymerizable functional group: methacryloyloxy group.

TABLE 1

| | Prep. Ex. No. | | |
|---|---|---|---|
| Monomer Composition (parts by weight) | 1 | 2 | 3 |
| Polyethylene Glycol Monomethacrylate | 25 | 25 | 10 |
| Polypropylene Glycol Monomethacrylate | 0 | 0 | 15 |
| Methacrylic Acid | 12 | 12 | 12 |
| Styrene Monomer | 63 | 53 | 53 |
| Styrenic Macromer | 0 | 10 | 10 |
| Weight-Average Molecular Weight of | 50000 | 57000 | 55000 |
| Polymer | | | |

### Examples 1 to 3

Six parts by weight of a polymer obtained by drying each polymer solution obtained in Preparation Examples 1 to 3 under reduced pressure was dissolved in 45 parts by weight of methyl ethyl ketone, and 1.41 parts by weight of a neutralizing agent (20% aqueous sodium hydroxide) was added thereto to neutralize a salt-forming group. Thereafter, 18 parts by weight of a copper phthalocyanine pigment [C.I. Pigment Blue 15:4 commercially available from TOYO INK MFG. CO., LTD. under the trade name of LIONOL BLUE FG-7400-G] was added to the mixture, and the resulting mixture was kneaded with a beads-mill for 2 hours.

One-hundred and twenty parts by weight of ion-exchanged water was added to the resulting kneaded mixture with stirring. Thereafter, methyl ethyl ketone was removed from the mixture at 60° C. under reduced pressure, and a part of water was further removed from the mixture, to give an aqueous dispersion of water-insoluble vinyl polymer particles containing a colorant, the solid content of which was 20% by weight.

Forty parts by weight of the obtained aqueous dispersion of vinyl polymer particles containing a colorant, 10 parts by weight of glycerol, 5 parts by weight of 2-pyrrolidone, 2 parts by weight of isopropanol and 43 parts by weight of ion-exchanged water were mixed together. The resulting mixture was filtered with a 25-mL needle-less syringe [commercially available from TERUMO CORPORATION] equipped with a 0.5 μm filter [acetyl cellulose membrane, outer diameter: 2.5 cm, commercially available from Fuji Photo Film Co., Ltd.], thereby removing coarse grains, to give a water-based ink having the composition as shown in Table 2.

### Comparative Example 1

The same procedures as in Example 2 were carried out except that C.I. Pigment Blue 15:3 commercially available from TOYO INK MFG. CO., LTD. under the trade name of LIONOL BLUE 7350 was used in place of C.I. Pigment Blue 15:4 commercially available from TOYO INK MFG. CO., LTD. under the trade name of LIONOL BLUE FG-7400-G as a copper phthalocyanine pigment, to give a water-based ink having the composition as shown in Table 2.

### Comparative Example 2

Eighteen parts by weight of C.I. Pigment Blue 15:4 commercially available from commercially available from TOYO INK MFG. CO., LTD. under the trade name of LIONOL BLUE FG-7400-G as a copper phthalocyanine pigment and 6 parts by weight of an anionic surfactant commercially available from Kao Corporation under the trade name of ELECTROSTRIPPER F (ingredient: potassium polyoxyethylene alkyl ether phosphate) were added to 76 parts by weight of ion-exchanged water, and the resulting mixture was kneaded with a beads-mill for 2 hours, to give an aqueous dispersion of pigment particles, the solid content of which was 20% by weight. The same procedures as in Example 2 were carried out using the resulting aqueous dispersion, to give a water-based ink having the composition as shown in Table 2.

### Comparative Example 3

The same procedures as in Comparative Example 2 were carried out except that C.I. Pigment Blue 15:3 commercially available from TOYO INK MFG. CO., LTD. under the trade name of LIONOL BLUE 7350 was used in place of C.I. Pigment Blue 15:4 commercially available from TOYO INK MFG. CO., LTD. under the trade name of LIONOL BLUE FG-7400-G as a copper phthalocyanine pigment, to give a water-based ink having the composition as shown in Table 2.

Next, the physical properties of the water-based inks obtained were evaluated in accordance with the following methods. The results are shown in Table 2.

(1) Viscosity of Ink

The viscosity of an ink was determined at 20° C. and 100 r/min using RE80L VISCOMETER (Rotor 1) commercially available from Toki Sangyo K.K., and evaluated on the basis of the following evaluation criteria.

[Evaluation Criteria]

⊚: Viscosity of an ink being less than 3.5 mPa·s

◯: Viscosity of an ink being at least 3.5 mPa·s and less than 4.5 mPa·s

Δ: Viscosity of an ink being at least 4.5 mPa·s and less than 7.0 mPa·s

x: Viscosity of an ink being at least 7.0 mPa·s

(2) Jetting Stability

The jetting stability was evaluated on the basis of the following evaluation criteria by jetting an ink from a printer using an inkjet printer commercially available from EPSON, under the Model Number of EM900C.

[Evaluation Criteria]

◯: Excellently jetting in all the nozzles

Δ: Jetting failure in a part of nozzles

x: Jetting failure

(3) Gloss

Solid image printing was carried out on a gloss paper commercially available from SEIKO EPSON CORPORATION under the trade name of MC Gloss Paper and product number of KA420MK using the above-mentioned printer, and the printed image was allowed to stand at 25° C. for 1 hour, and thereafter its gloss was determined by a glossmeter commercially available from Nippon Denshoku Kogyo K.K. under the trade name of HANDY GLOSSMETER with the product number of PG-1, and evaluated on the basis of the following evaluation criteria.

[Evaluation Criteria]

⊚: Gloss being at least 40

◯: Gloss being at least 35 and less than 40

Δ: Gloss being at least 30 and less than 35

x: Gloss being less than 30

(4) Optical Density

Solid image printing was carried out on a plain sheet of paper commercially available from SEIKO EPSON CORPORATION under the trade name of KA4250NP using the above-mentioned printer, and the printed image was allowed to stand at 25° C. for 1 hour. Thereafter, its optical density was determined by a Macbeth densitometer commercially available from Macbeth Process Measurements Co. under the Product Number of RD914, and evaluated on the basis of the following evaluation criteria.

[Evaluation Criteria]

⊚: Optical density being at least 1.2

◯: Optical density being at least 1.1 and less than 1.2

Δ: Optical density being at least 1.0 and less than 1.1

x: Optical density being less than 1.0

(5) Light-Fastness

The printed image formed by the solid image printing which was used for determining the above-mentioned optical density was irradiated for 10000 counts consecutively using a xenon Fade-O-meter commercially available from ATLAS™. Thereafter, the optical density of the same printed portion as the optical density before irradiation was determined again by the Macbeth densitometer RD914. The residual ratio of the optical density after irradiation to the optical density before irradiation was determined by the equation:
[Residual Ratio]=([Optical Density after Irradiation]/[Optical Density before Irradiation])×100

The light-fastness was evaluated on the basis of the following evaluation criteria.

[Evaluation Criteria]

⊚: Residual ratio being at least 95%

◯: Residual ratio being at least 80% and less than 95%

Δ: Residual ratio being at least 60% and less than 80%

x: Residual ratio being less than 60%

(6) Water Resistance

Solid image printing was carried out on the above-mentioned plain sheet of paper using the above-mentioned printer, and the printed image was dried at 25° C. for 1 hour. The optical density of the specified printed portion of the obtained sample was determined, and thereafter the printed copy paper was immersed vertically in stand-still water for 10 seconds, and the paper was lifted vertically therefrom. After air-drying the paper at 25° C. for 24 hours, the optical density of the same printing portion as the optical density before immersion was determined. The residual ratio of the optical density after immersion to the optical density before immersion was determined by the following equation:
[Residual Ratio]=([Optical Density after Immersion]/[Optical Density before Immersion])×100

The water resistance was evaluated on the basis of the following evaluation criteria.

[Evaluation Criteria]

⊚: Residual ratio being at least 95%

◯: Residual ratio being at least 80% and less than 95%

Δ: Residual ratio being at least 60% and less than 80%

x: Residual ratio being less than 60%

(7) Rubbing Resistance

Solid image printing was carried out on the above-mentioned plain sheet of paper using the above-mentioned printer. After the printed paper was dried at 25° C. for 24 hours, the printed surface was strongly rubbed with a finger. The extent of rub-off of the printed image was evaluated on the basis of the following evaluation criteria.

[Evaluation Criteria]

⊚: No printed image being rubbed off at all

◯: Substantially no printed image being rubbed off, and its periphery being not stained

Δ: Some printed image being rubbed off, its periphery being slightly stained, and finger also being slightly stained

x: Printed image being considerably rubbed off, its periphery being considerably stained, and finger also being considerably stained

(8) Average Particle Diameter and Dispersion Stability

The average particle diameter of the polymer particles containing a colorant, being contained in an ink (hereinafter referred to as the average particle diameter before storage) was determined using a laser particle analyzer system commercially available from Otsuka Denshi K.K. under the trade name of ELS-8000. The ink was stored in a tightly sealed container for 1 month in a thermostat kept at 60° C., and thereafter the average particle diameter (hereinafter referred to as the average particle diameter after storage) was determined in the same manner as the above.

As an index for dispersion stability, the dispersion stability was determined by the following equation:
[Dispersion Stability]=([Average Particle Diameter after Storage]/[Average Particle Diameter before Storage])×100

The dispersion stability was evaluated on the basis of the following evaluation criteria.

[Evaluation Criteria]

⊚: Dispersion stability being at least 95% and less than 105%

◯: Dispersion stability being at least 90% and less than 95%, or at least 105% and less than 110%

Δ: Dispersion stability being at least 70% and less than 90%, or at least 110% and less than 130%

x: Dispersion stability being less than 70% or at least 130%

(9) Angular Dependency of Color Tone

When changing an angle of observing a printout, a color tone may change in some cases. The change in color tone when changing the determination angles can be evaluated by goniospectrophotometer.

Solid image printing was carried out on a gloss paper commercially available from SEIKO EPSON CORPORATION under the trade name of MC Gloss Paper and product number of KA420MK, and the paper was dried at 25° C. for 24 hours. Thereafter, CIBLAB was determined when a light-intercepting angle was varied from −80° to 80° at an angle of incidence of −45° by goniospectrophotometer commercially available from Murakami Color Research Laboratory under the product number of GCMS-4, and the change in a* was observed.

[Evaluation Criteria]

⊚: The maximum change in a* being less than 40.

◯: The maximum change in a* being at least 40 and less than 50.

Δ: The maximum change in a* being at least 50 and less than 60.

x: The maximum change in a* being at least 60.

TABLE 2

| | Ex. No. and Comp. Ex. No. | | | | | |
|---|---|---|---|---|---|---|
| | | | | Comp. | Comp. | Comp. |
| | Ex. 1 | Ex. 2 | Ex. 3 | Ex. 1 | Ex. 2 | Ex. 3 |
| Kind of Polymer* | Prep. | Prep. | Prep. | Prep. | None | None |
| | Ex. 1 | Ex. 2 | Ex. 3 | Ex. 2 | | |
| Degree of | 100 | 100 | 100 | 100 | — | — |
| Neutralization (%) | | | | | | |
| Kind of C.I. Pigment Blue | 15:4 | 15:4 | 15:4 | 15:3 | 15:4 | 15:3 |
| Composition of Water- | | | | | | |
| Based Ink (% by weight) | | | | | | |
| Solid Content of | 8.0 | 8.0 | 8.0 | 8.0 | 8.0 | 8.0 |
| Aqueous Dispersion | | | | | | |
| Glycerol | 10.0 | 10.0 | 10.0 | 10.0 | 10.0 | 10.0 |
| 2-Pyrrolidone | 5.0 | 5.0 | 5.0 | 5.0 | 5.0 | 5.0 |
| Isopropanol | 2.0 | 2.0 | 2.0 | 2.0 | 2.0 | 2.0 |
| Ion-Exchanged Water | 75.0 | 75.0 | 75.0 | 75.0 | 75.0 | 75.0 |
| Physical Properties of | | | | | | |
| Water-Based Ink | | | | | | |
| Viscosity of Ink | ◯ | ◯ | ◯ | ◯ | X | X |
| Jetting Stability | ◯ | ◯ | ◯ | ◯ | X | X |
| Gloss | ◯ | ◯ | ◯ | ◯ | X | X |
| Optical Density | ◯ | ◯ | ◯ | ◯ | X | X |
| Light-Fastness | ◯ | ◯ | ◯ | ◯ | X | X |
| Water Resistance | ◯ | ⊚ | ⊚ | ⊚ | X | X |
| Rubbing Resistance | ◯ | ⊚ | ⊚ | ⊚ | X | X |
| Average Particle | 0.15 | 0.16 | 0.15 | 0.15 | 0.32 | 0.30 |
| Diameter (μm) | | | | | | |
| Dispersion Stability | ◯ | ◯ | ◯ | ◯ | X | X |
| Angular Dependency | ⊚ | ⊚ | ⊚ | Δ | X | X |
| of Color Tone | | | | | | |

(Note)
*Prep. Ex. No. listed in the row of “Kind of Polymer” means that the aqueous dispersion obtained in its Preparation Example was used.

It can be seen from the results shown in Table 2 that all of the water-based inks obtained in the Examples are excellent in jetting stability since each of these inks has a low viscosity, respectively. Also, it can be seen that the water-based inks obtained in Examples give printouts containing printed characters high optical density and high gloss in the case of a gloss paper. Furthermore, it can be seen that the water-based inks obtained in Examples are excellent in angular dependency of color tone, light-fastness, water resistance, rubbing resistance and dispersion stability.

As explained above, since the water-based ink containing an aqueous dispersion of the present invention is excellent in angular dependency of color tone, water resistance, light-fastness, rubbing resistance, gloss and dispersion stability, the water-based ink can give a high optical density. Also, since the water-based ink of the present invention is further excellent in jetting stability and can give high optical density, the water-based ink can be suitably used as a water-based ink for inkjet recording.

1-10. (canceled)

11: An aqueous dispersion comprising water-insoluble vinyl polymer particles, which comprise a water-insoluble vinyl polymer and C.I. Pigment Blue 15:4 as a colorant, wherein said water-insoluble vinyl polymer is prepared by polymerizing a monomer composition comprising:
(A) 5 to 45% by weight of a monomer A represented by formula (I): 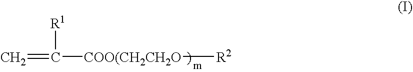
wherein R¹ is a hydrogen atom or a methyl group; R² is a hydrogen atom, an alkyl group having 1 to 20 carbon atoms or a phenyl group which may have an alkyl group having 1 to 9 carbon atoms; and m is a number of 1 to 30;
(B) 5 to 45% by weight of at least one monomer selected from the group consisting of:
a monomer B1 represented by formula (II): 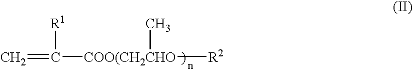
wherein R¹ and R² are as defined above; and n is a number of 1 to 30,
a monomer B2 represented by formula (III): 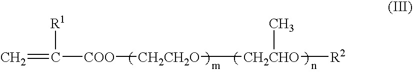
wherein R¹, R² , m and n are as defined above, and the oxypropylene group and oxytetramethylene group are present in a block or random form,
a monomer B3 represented by the formula (IV): 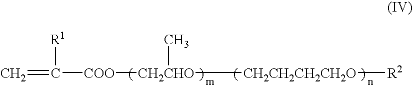
wherein R¹, R², m and n are as defined above, and the oxypropylene group and oxytetramethylene group are present in a block or random form;
(C) 3 to 40% by weight of a monomer having a salt-forming group; and
(D) 15 to 87% by weight of at least one copolymerizable styrenic macromer monomer copolymerizable with the monomer A, the monomer B1, the monomer B2, the monomer B3 and the monomer having a salt-forming group,
wherein the total content of the monomer A and the monomer B in the monomer composition is at least 10% by weight, and the amount of the polymer is 20 to 200 parts by weight based on 100 parts by weight of C.I. Pigment Blue 15:4.

12: The aqueous dispersion according to claim 11, wherein the total content of the monomer A and the monomer B in the monomer composition is 10 to 45% by weight.

13: A water-based ink comprising the aqueous dispersion according to claim 11.

14: The water-based ink according to claim 13, wherein the total content of the monomer A and the monomer B in the monomer composition is 10 to 45% by weight.

15: The aqueous dispersion according to claim 11, wherein the water-insoluble vinyl polymer consists of polymerized monomer units of monomers (A), (B), (C) and (D).

16: The aqueous dispersion according to claim 11, wherein the water-insoluble vinyl polymer particles consist of a water-insoluble vinyl polymer prepared by polymerizing a monomer composition comprising monomers having only a single ethylenically unsaturated group.

17: The aqueous dispersion according to claim 11, wherein the monomer (C) is at least one selected from the group consisting of an unsaturated carboxylic monomer, an unsaturated sulfonic monomer, and an unsaturated phosphoric acid monomer.

18: The aqueous dispersion according to claim 11, wherein the water-insoluble vinyl polymer particles consist of a water-insoluble vinyl polymer consisting of polymerized monomer units of polyethylene glycol monomethacrylate, polypropylene glycol monomethacrylate, methacrylic acid, styrene, and a styrenic macromer having a polymerizable methacryloyloxy group.

19: The water-based ink according to claim 14, wherein the water-insoluble vinyl polymer particles consist of a water-insoluble vinyl polymer consisting of polymerized monomer units of polyethylene glycol monomethacrylate, polypropylene glycol monomethacrylate, methacrylic acid, styrene, and a styrenic macromer having a polymerizable methacryloyloxy group.

20: The water-based ink according to claim 14, wherein the monomer (C) is at least one selected from the group consisting of an unsaturated carboxylic monomer, an unsaturated sulfonic monomer, and an unsaturated phosphoric acid monomer.

21: The water-based ink according to claim 14, having an angular dependency of color tone having maximum change in a* of less than 40.

22: The aqueous dispersion according to claim 11, wherein the water-insoluble vinyl polymer particles consist of a water-insoluble vinyl polymer containing polymerized monomer units of monomers (A), (B), (C), and (D).

23: The water-based ink according to claim 14, wherein the water-insoluble vinyl polymer particles consist of a water-insoluble vinyl polymer containing polymerized monomer units of only monomers (A), (B), (C), and (D).

24: The aqueous dispersion according to claim 11, wherein (D) is a styrenic macromer.

25: The aqueous dispersion of claim 11, wherein the water-insoluble polymer comprises polymerized units of polyethylene glycol monomethacrylate, polypropylene monomethacrylate, methacrylic acid, styrenic monomer and styrenic macromer.
